(19) United States
(12) Patent Application Publication
(10) Pub. No.: US 2007/0242403 A1
(43) Pub. Date: Oct. 18, 2007

(54) Power supply protection circuit for an in-vehicle electronic device

(75) Inventor: Naruki Suetake, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: MITSUBISHI ELECTRIC CORPORATION

(21) Appl. No.: 11/452,931

(22) Filed: Jun. 15, 2006

(30) Foreign Application Priority Data
Apr. 14, 2006 (JP) 2006-112006

(51) Int. Cl. H02H 3/20; H02H 9/04

(52) U.S. Cl. 361/91.1

(57) ABSTRACT

Provided is a power supply protection circuit for an in-vehicle electronic device, for protecting a power supply of a circuit to be protected which is installed in the in-vehicle electronic device, including a battery power supply for the in-vehicle electronic device, a diode whose anode terminal is connected therewith, a transistor whose collector terminal is connected with a cathode terminal of the diode and whose emitter terminal is connected with a power supply voltage supplying terminal of the circuit to be protected, and a Zener diode provided between the battery power supply and a ground terminal to be connected in series with a resistor having an anode terminal connected with the ground terminal and a cathode terminal connected with the resistor and a base terminal of the transistor.

### BACKGROUND OF THE INVENTION

1. Field of the Invention

The present invention relates to a power supply protection circuit for an in-vehicle electronic device, and more particularly, to a power supply protection circuit for an in-vehicle electronic device which is suitably applicable to a thermal flowmeter for detecting a flow rate of a fluid using a thermal resistor in which a circuit to be protected uses a CMOS process IC.

2. Description of the Related Art

A battery of a vehicle normally has a voltage of approximately 12 V to 16 V. However, a so-called abnormal voltage such as a high voltage or a negative voltage may be produced by a generator regulator failure, a jumpstart using two connected batteries, a generation of noise signals, an application of a reverse voltage which is caused by handling at the time of service, or the like.

In general, a power supply voltage of a thermal flowmeter used for an in-vehicle electronic device is supplied from a battery, so the flow meter is in an environment in which the abnormal voltage is applied thereto. Therefore, it is necessary to prevent the flowmeter from breaking or malfunctioning.

On the other hand, an IC is normally used for an electronic device of the flowmeter. In particular, for an addition of a memory function and a reduction in IC chip size, a CMOS process IC may be employed. At this time, the CMOS process IC has a withstanding voltage lower than that of a bipolar process IC, so a protection circuit for limiting a power supply voltage of the IC is generally required.

Up to now, the above-mentioned power supply protection circuit for an in-vehicle electronic device includes a power supply protection circuit for supplying a power supply voltage of a circuit power supply of a circuit to be protected from a battery power supply through a forward diode (for example, see JP 2002-159136 A).

In such a power supply protection circuit, when a power supply voltage of the battery power supply is expressed by Vbat, the power supply voltage of the circuit power supply is expressed by Vdd, and a forward drop voltage of the diode is expressed by Vf2, the power supply voltage Vdd of the circuit power supply is as follows.

```
A1) When Vbat ≦ Vf2,
      Vdd = 0.
A2) When Vbat > Vf2,
      Vdd = Vbat − Vf2.
```

### That is, a negative voltage can be limited by a relationship between the power supply voltage Vbat of the battery power supply and the power supply voltage Vdd of the circuit power supply.

In addition, up to now, another power supply protection circuit for an in-vehicle electronic device includes a power supply protection circuit for supplying a power supply voltage of a circuit power supply of a circuit to be protected from a battery power supply through a resistor, in which a Zener diode for limiting a supplying voltage is connected in parallel with the circuit to be protected (for example, see JP 2003-121230 A).

In such a power supply protection circuit, when a power supply voltage of the battery power supply is expressed by Vbat, the power supply voltage of the circuit power supply is expressed by Vdd, a resistance value of the resistor is expressed by R2, a consumption current of the resistor is expressed by I2, a Zener voltage of the Zener diode is expressed by Vz2, and a forward drop voltage of the Zener diode is expressed by Vzf2, the power supply voltage Vdd of the circuit power supply is as follows.

```
B1) When Vbat ≦ −Vzf2,
      Vbat = −Vzf2.
B2) When Vbat > −Vzf2 and Vdd < Vz2,
      Vdd = Vbat − R2 × I2.
B3) When Vbat > −Vzf2 and Vdd ≧ Vz2,
      Vdd = Vz2.
```

### That is, an overvoltage and a negative voltage equal to or lower than −Vzf2 can be limited by a relationship between the power supply voltage Vbat of the battery power supply and the power supply voltage Vdd of the circuit power supply.

However, with respect to the conventional techniques, in the case of the invention described in JP 2002-159136 A, only the negative voltage is limited and thus an overvoltage cannot be limited, so an additional overvoltage protection circuit is required. In the case of the invention described in JP 2003-121230 A, the overvoltage and the negative voltage can be limited. However, in order to suppress voltage drop caused by the consumption current flowing through the resistor, it is necessary to set the resistance value R2 of the resistor to a small value. As a result, it is required that the resistor and the Zener diode become high-voltage withstanding specifications, in particular, the Zener diode becomes a power Zener diode.

When the circuit to be protected includes the bipolar process IC, it is relatively easy to realize an IC chip having a protective function corresponding to that of the power Zener diode. However, in the case of CMOS process IC, it is difficult that the IC chip has the protective function, so that the power Zener diode is required as a part different from the IC.

At this time, the power Zener diode is generally larger in size, so the degree of freedom of design is significantly reduced particularly in the case of a product such as a flowmeter, for which a reduction in size thereof is required in recent years. In general, the power Zener diode is expensive, so that there is a problem in that a cost becomes higher with an increase in size of an amplifier case covering the power Zener diode.

### SUMMARY OF THE INVENTION

The present invention has been made to solve the above-mentioned problems. An object of the present invention is to obtain a power supply protection circuit for an in-vehicle electronic device in which a reduction in size of a circuit part can be realized and is inexpensive without using a power Zener diode.

A power supply protection circuit for an in-vehicle electronic device according to the present invention is a power supply protection circuit for protecting a power supply of a circuit to be protected which is installed in the in-vehicle electronic device. The power supply protection circuit for an in-vehicle electronic device includes: a diode whose anode terminal is connected with the power supply of the in-vehicle electronic device; a transistor whose collector terminal is connected with a cathode terminal of the diode and whose emitter terminal is connected with a power supply voltage supplying terminal of the circuit to be protected; a resistor whose one end is connected with the power supply of the in-vehicle electronic device; and a Zener diode which is provided between other end of the resistor and a ground terminal to be connected in series with the resistor and which includes an anode terminal connected with the ground terminal and a cathode terminal connected with the resistor and a base terminal of the transistor.

According to the present invention, the power supply protection circuit for an in-vehicle electronic device is composed of small power parts without using a power Zener diode to limit both an overvoltage and a negative voltage. Therefore, it is possible to improve a protection function and realize a reduction in size of a circuit part, and construct an inexpensive power supply protection circuit.

### BRIEF DESCRIPTION OF THE DRAWINGS

In the accompanying drawings:

FIG. 1 is a circuit diagram showing a structure of a power supply protection circuit for an in-vehicle electronic device according to an embodiment of the present invention; and

FIG. 2 is a graph showing a characteristic between a power supply voltage Vbat of a battery power supply 1 and a power supply voltage Vdd of a circuit to be protected 3 as shown in FIG. 1.

### DETAILED DESCRIPTION OF THE PREFERRED EMBODIMENT

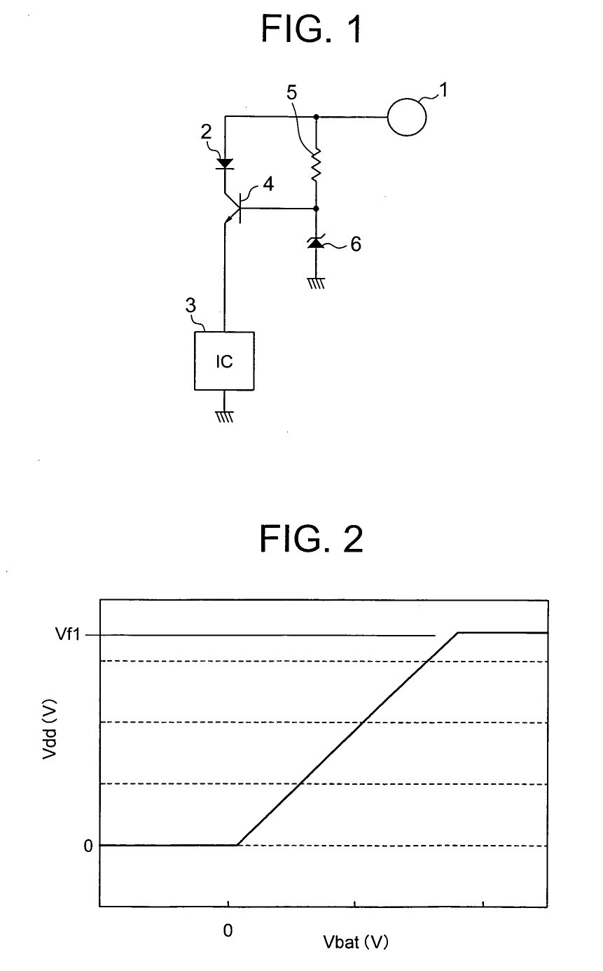

Hereinafter, an embodiment of the present invention will be described with reference to FIGS. 1 and 2. FIG. 1 is a circuit diagram showing a structure of a power supply protection circuit for an in-vehicle electronic device according to the embodiment of the present invention. A circuit to be protected for which power supply voltage protection is necessary is a CMOS process IC for a thermal flowmeter.

The power supply protection circuit for an in-vehicle electronic device as shown in FIG. 1 includes a diode 2 whose anode terminal is connected with a battery power supply 1 for the in-vehicle electronic device, a transistor 4 whose collector terminal is connected with a cathode terminal of the diode 2 and whose emitter terminal is connected with a power supply voltage supplying terminal of a circuit to be protected 3, and a Zener diode 6 which is provided between the battery power supply 1 and a ground terminal so as to be connected in series with a resistor 5 which has an anode terminal connected with the ground terminal and a cathode terminal connected with the resistor 5 and a base terminal of the transistor 4.

In the power supply protection circuit for the in-vehicle electronic device as shown in FIG. 1, assume that a power supply voltage of the battery power supply 1 is expressed by Vbat, a forward drop voltage of the diode 2 is expressed by Vf1, a collector-emitter saturation voltage of the transistor 4 and a base-emitter voltage are expressed by Vce(sat) and Vbe, respectively, a power supply voltage of the circuit to be protected 3 is expressed by Vdd, a resistance value of the resistor 5 and a consumption current thereof are expressed by R1 and I1, respectively, and a Zener voltage of a Zener diode 6 is expressed by Vz1. Then, the power supply voltage Vdd of the circuit to be protected 3 is as follows.

```
1) When Vbat ≦ 0 V,
    Vdd = 0 V.
2) When 0 < Vbat ≦ Vz1:
    I) in case where R1 × I1 + Vbe > Vf1 + Vce(sat),
        Vdd = Vbat − R1 × I1 − Vbe; and
    II) in case where R1 × I1 + Vbe < Vf1 + Vce(sat),
        Vdd = Vbat − Vf1 − Vce(sat).
3) When Vbat > Vz1,
    Vdd = Vz1 − Vbe.
```

### At this time, a relationship between the power supply voltage Vbat of the battery power supply 1 and the power supply voltage Vdd of the circuit to be protected 3 is as shown in FIG. 2.

Therefore, the power supply voltage Vdd of the circuit to be protected 3 is limited to a voltage range of from 0 V to (Vz1−Vbe). At this time, when the Zener voltage Vz1 of the Zener diode 6 is selected so as to satisfy a withstanding voltage of the CMOS process IC which is the circuit to be protected 3, a power supply protection circuit for the IC can be constructed.

At this time, the consumption current flowing through the resistor 5 is sufficiently smaller than a circuit current flowing into the circuit to be protected 3 through the diode 2 and the transistor 4. Therefore, it is unnecessary to set the resistor 5 and the Zener diode 6 to high-voltage withstanding specifications. On the other hand, the transistor 4 requires a withstanding voltage. However, a size thereof is smaller than that of a conventional power Zener diode, so that an inexpensive transistor can be used.

As described above, the power supply protection circuit for the in-vehicle electronic device as shown in FIG. 1 is composed of small power parts without using an expensive power Zener diode. In addition, as shown in FIG. 2, the power supply voltage Vdd of the circuit to be protected 3 is limited to a range of from a minimum voltage of 0 V to a maximum voltage of (Vz1−Vbe) to limit both an overvoltage and a negative voltage as in a conventional case. Thus, it is possible to improve a protective function and realize a reduction in size of a circuit part, with the result that an inexpensive power supply protection circuit can be provided.

In particular, when the comparison with specifications using the power Zener diode is made, a manufacturing cost can be reduced by approximately ½ times. In addition, it is possible to narrow an area necessary for mounting by approximately ½ times and to lower a mounting height by approximately ½ times, thereby realizing a reduction in size.

The voltage drop of the power supply protection circuit is small. Therefore, even when the power supply voltage Vbat of the battery power supply 1 becomes a lower voltage, it is advantageous to ensure the circuit power supply voltage. That is, when the power supply voltage Vbat of the battery power supply 1 becomes the lower voltage, the power supply voltage Vdd of the circuit to be protected 3 depends on one of

(Vf1+Vce(sat))

and

(R1×I1+Vbe)

with a higher voltage and does not become a value obtained by adding both voltage values. Thus, even when the power supply voltage Vbat of the battery power supply 1 becomes the lower voltage, it is advantageous to ensure the circuit power supply voltage.

What is claimed is:

1. A power supply protection circuit for an in-vehicle electronic device, for protecting a power supply of a circuit to be protected which is installed in the in-vehicle electronic device, comprising:
a diode whose anode terminal is connected with the power supply of the in-vehicle electronic device;
a transistor whose collector terminal is connected with a cathode terminal of the diode and whose emitter terminal is connected with a power supply voltage supplying terminal of the circuit to be protected;
a resistor whose one end is connected with the power supply of the in-vehicle electronic device; and
a Zener diode which is provided between other end of the resistor and a ground terminal to be connected in series with the resistor and which includes an anode terminal connected with the ground terminal and a cathode terminal connected with the resistor and a base terminal of the transistor.

2. A power supply protection circuit for an in-vehicle electronic device according to claim 1, wherein:
the circuit to be protected comprises a CMOS process IC; and
the Zener diode includes a Zener voltage set to a value satisfying a withstanding voltage of the IC.
